(19) United States
(12) Patent Application Publication
(10) Pub. No.: US 2024/0308449 A1
(43) Pub. Date: Sep. 19, 2024

(54) ROUTING MEMBER FIXING STRUCTURE, ELECTRICAL CONNECTION BOX, AND WIRE HARNESS

(71) Applicant: YAZAKI CORPORATION, Tokyo (JP)

(72) Inventors: Ayumu Kurizono, Makinohara-shi (JP); Tsukasa Saito, Makinohara-shi (JP); Yuta Masuda, Tokyo (JP)

(21) Appl. No.: 18/592,450

(22) Filed: Feb. 29, 2024

(30) Foreign Application Priority Data
Mar. 14, 2023 (JP) 2023-039222

(51) Int. Cl. B60R 16/023; H01B 7/00; H01B 7/40

(52) U.S. Cl. CPC B60R 16/0238; H01B 7/0045; H01B 7/40

(57) ABSTRACT

A routing member fixing structure applied to an electrical connection box and a wire harness includes a first divided body and a second divided body joined to each other to compose a routing member insertion section into which a routing member is inserted, a first tying member and a second tying member each formed to have a band shape, a first band fixing section tying and fixing the first divided body and the routing member together by winding the first tying member around the first divided body and the routing member, and a second band fixing section tying and fixing the first divided body and the second divided body together by winding the second tying member around the first divided body and the second divided body.

### CROSS-REFERENCE TO RELATED APPLICATION (S)

The present application claims priority to and incorporates by reference the entire contents of Japanese Patent Application No. 2023-039222 filed in Japan on Mar. 14, 2023.

### BACKGROUND OF THE INVENTION

### 1. Field of the Invention

The present invention relates to routing member fixing structures, electrical connection boxes, and wire harnesses.

### 2. Description of the Related Art

For example, Japanese Patent Application Laid-open No. 2014-171318 discloses an electrical connection box including a frame provided with a gutter-shaped wire harness lead-out section, a cover attached to the frame, and a tying band fixing a wire harness to the wire harness lead-out section.

The aforementioned electrical connection box described in Japanese Patent Application Laid-open No. 2014-171318 leaves room for further improvement in measures against a routing member getting caught at a routing member insertion section formed by joining two members, for example.

### SUMMARY OF THE INVENTION

In light of the foregoing, an object of the present invention is to provide a routing member fixing structure, an electrical connection box, and a wire harness that can properly prevent a routing member from getting caught.

In order to achieve the above mentioned object, a routing member fixing structure according to one aspect of the present invention includes a first divided body and a second divided body configured to be joined to each other to compose a routing member insertion section into which a routing member is inserted; a first tying member and a second tying member each formed to have a band shape; a first band fixing section configured to tie and fix the first divided body and the routing member together by winding the first tying member around the first divided body and the routing member; and a second band fixing section configured to tie and fix the first divided body and the second divided body together by winding the second tying member around the first divided body and the second divided body.

In order to achieve the above mentioned object, an electrical connection box according to another aspect of the present invention includes a housing configured to accommodate an electronic component; and a routing member fixing structure disposed at the housing and configured to fix a routing member, the routing member fixing structure including: a first divided body and a second divided body composing part of the housing and configured to be joined to each other to compose a routing member insertion section into which the routing member is inserted; a first tying member and a second tying member each formed to have a band shape; a first band fixing section configured to tie and fix the first divided body and the routing member together by winding the first tying member around the first divided body and the routing member; and a second band fixing section configured to tie and fix the first divided body and the second divided body together by winding the second tying member around the first divided body and the second divided body.

In order to achieve the above mentioned object, a wire harness according to still another aspect of the present invention includes a routing member having conductivity; and an electrical connection box configured to be connected to the routing member, the electrical connection box including: a housing configured to accommodate an electronic component; and a routing member fixing structure disposed at the housing and configured to fix the routing member, and the routing member fixing structure including: a first divided body and a second divided body composing part of the housing and configured to be joined to each other to compose a routing member insertion section into which the routing member is inserted; a first tying member and a second tying member each formed to have a band shape; a first band fixing section configured to tie and fix the first divided body and the routing member together by winding the first tying member around the first divided body and the routing member; and a second band fixing section configured to tie and fix the first divided body and the second divided body together by winding the second tying member around the first divided body and the second divided body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a schematic configuration of an electrical connection box according to an embodiment;

FIG. 2 is a sectional view that is taken along an extending direction of a routing member insertion section according to the embodiment and that is for describing a routing member fixing structure disposed at the routing member insertion section;

FIG. 3 is a diagram for describing a first band fixing section according to the embodiment;

FIG. 4 is a side view for describing the first band fixing section according to the embodiment;

FIG. 5 is a side view for describing the first band fixing section according to the embodiment;

FIG. 6 is a diagram for describing a second band fixing section according to the embodiment;

FIG. 7 is a side view for describing the second band fixing section according to the embodiment; and

FIG. 8 is a side view for describing the second band fixing section according to the embodiment.

### DETAILED DESCRIPTION OF THE PREFERRED EMBODIMENTS

Embodiments according to the present invention will be described in detail below with reference to the drawings. Note that these embodiments should not be construed to limit this invention. Constituents in the following embodiments include constituents that can be readily substituted by those skilled in the art or that are substantially the same.

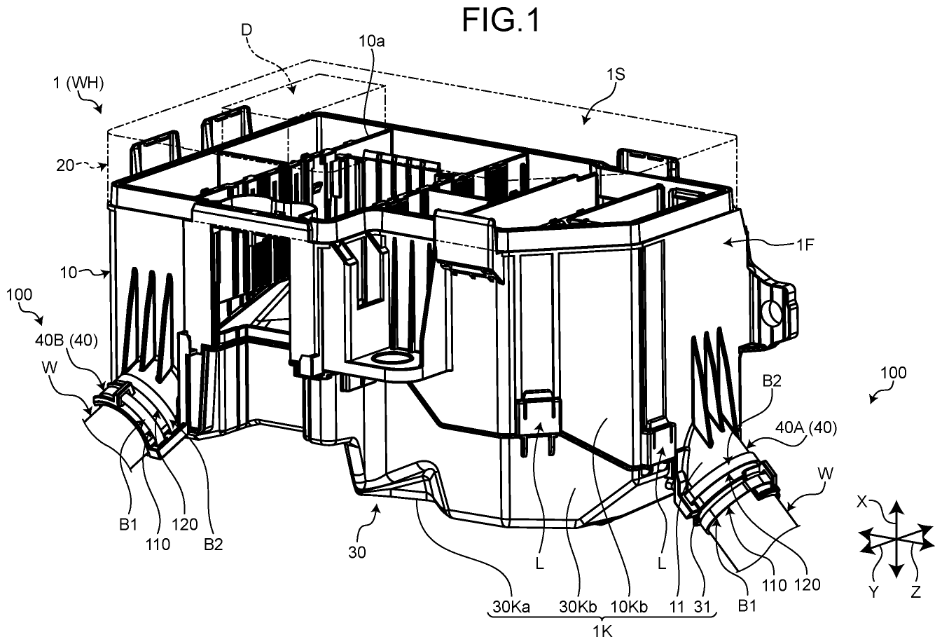

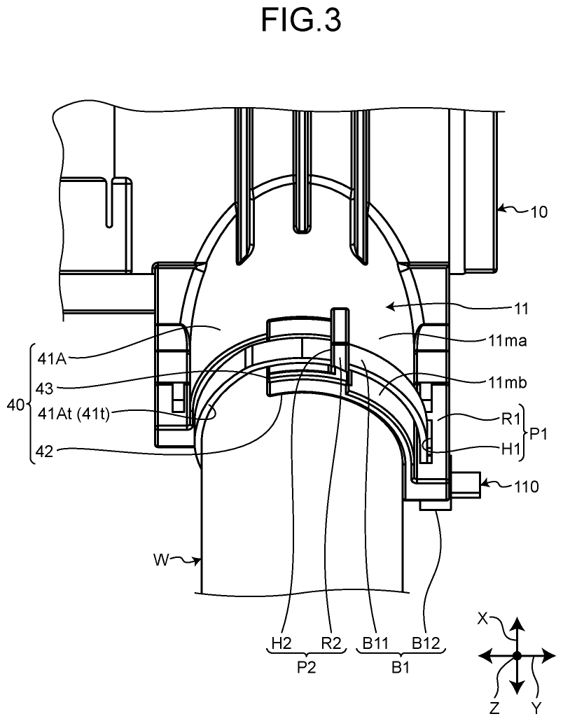

Note that, for convenience of description, FIG. 1 omits a top cover assembled to a frame of an electrical connection box, an electronic component accommodated in the frame, and the like. For convenience of description, FIGS. 3, 4, and 5 omit a bottom cover assembled to the frame, a second tying member, and the like.

### Embodiments

A wire harness WH according to this embodiment is, for example, for connecting a plurality of routing members W used for power supply and signal communication to devices mounted in a vehicle by using connectors and the like to connect the devices to each other.

The wire harness WH includes the routing members W having conductivity and an electrical connection box 1 accommodating an electronic component D and connected to the electronic component D. The routing members W are composed of, for example, a metal bar, an electric wire, a bundle of electric wires, and the like. The metal bar is a conductive bar-shaped member having an outer side covered with an insulating sheath. The electric wire is a conductor (core wire) made from a plurality of conductive metal strands and having an outer side covered with an insulating sheath. Note that the wire harness WH may include not only these but also a protector, an exterior member, a fixing tool, and the like.

The electrical connection box 1 consolidates and accommodates therein the electronic component D, such as a connector, a fuse, a relay, a capacitor, a branch, an electronic control unit, and an electronic component unit in which these are unitized. The electrical connection box 1 is installed in, for example, an engine room or an interior of the vehicle. The electrical connection box 1 is connected between a power source, such as a battery, and various electronic devices mounted in the vehicle via the routing members W and the like. The electrical connection box 1 distributes power supplied from the power source to the various electronic devices in the vehicle. The electrical connection box 1 is also called a junction box, a fuse box, a relay box, and the like in some cases. In this embodiment, these are collectively called an electrical connection box. Note that, although each constituent of the electrical connection box 1 of this embodiment is described in detail later, the electrical connection box 1 includes a housing 1F as illustrated in FIG. 1. The housing 1F includes a storage space 1S that is defined by a wall 1K surrounding therearound and that accommodates the electronic component D and routing member insertion sections 40 into which the routing members W connected to the electronic component D are inserted between the inside and the outside of the storage space 1S.

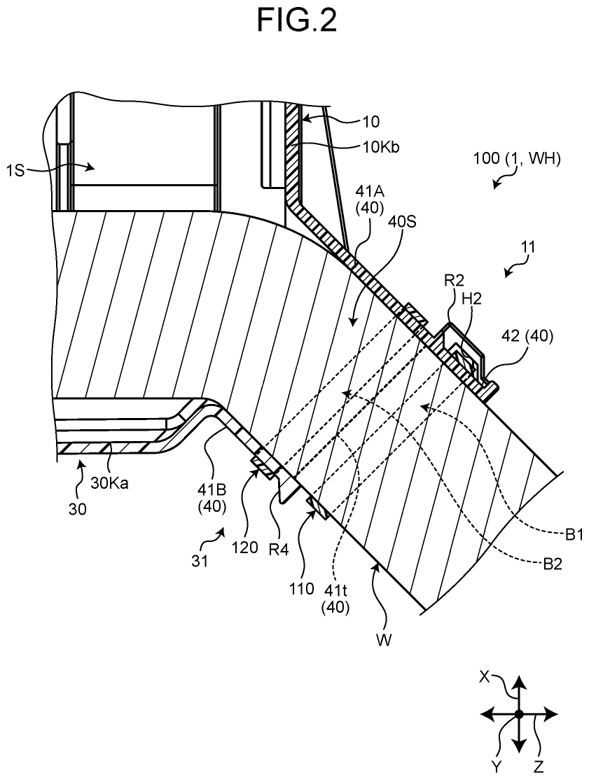

The electrical connection box 1 of this embodiment is provided with routing member fixing structures 100 at the routing member insertion sections 40, and the routing member insertion sections 40 to which the routing member fixing structures 100 are applied are composed of first divided bodies 11 and second divided bodies 31. In such a configuration, as illustrated in FIGS. 2 to 8, the routing member fixing structures 100 of this embodiment each include a first band fixing section 110 tying and fixing the routing member W and the first divided body 11 together by using a first tying member B1 and a second band fixing section 120 tying and fixing the first divided body 11 and the second divided body 31 together by using a second tying member B2. With this configuration, after the first divided body 11 and the second divided body 31 are joined with the routing member W fixed to the first divided body 11 via the first band fixing section 110, the first divided body 11 and the second divided body 31 are fixed via the second band fixing section 120, so that the routing member fixing structure 100 of this embodiment enables a configuration that can properly prevent the routing member W from getting caught. Each configuration of the electrical connection box 1 and the routing member fixing structure 100 will be described in detail below with reference to FIGS. 1 to 8.

Note that, in the following description, three directions crossing each other are referred to as “up-down direction X”, “first width direction Y”, and “second width direction Z” for convenience. Herein, the up-down direction X, the first width direction Y, and the second width direction Z are orthogonal to each other. One side in the up-down direction X is typically referred to as an upper portion or upper side, and the other side as a lower portion or lower side. Unless otherwise specified, each direction used in the following description is described as a direction with the electrical connection box 1 mounted in the vehicle.

### Electrical Connection Box

As illustrated in FIG. 1, the electrical connection box 1 includes the housing 1F and the routing member fixing structures 100 disposed at the housing 1F.

### Housing

The housing 1F is formed from an insulating resin material and includes a housing body 10, a top cover 20 attached to an upper portion of the housing body 10, and a bottom cover 30 attached to a lower portion of the housing body 10. By joining the top cover 20 and the bottom cover 30 to the housing body 10, the housing 1F is formed to have a shape like a hollow box as a whole. Thus, the electrical connection box 1 has a three-layer divided structure in which the housing body 10, the top cover 20, and the bottom cover 30 are divided from each other in the up-down direction X. The wall 1K of the electrical connection box 1 is composed of walls composing the housing body 10, the top cover 20, and the bottom cover 30. Thus, the electrical connection box 1 has the storage space 1S surrounded by part of the wall 1K to be defined inside the housing body 10, the top cover 20, and the bottom cover 30 stacked and assembled to each other.

The housing body 10 is a member composing a body of the electrical connection box 1 and is also referred to as a frame. As illustrated in FIG. 1, the housing body 10 is open on its upper and lower sides in the up-down direction X, and its entire periphery in the first width direction Y and the second width direction Z is surrounded by a side wall 10Kb, whereby the housing body 10 is formed to have a polygonal tubular shape (substantially rectangular tube). A space located inside the housing body 10 composes a portion of the storage space 1S.

The housing body 10 is provided inside with a frame portion 10a partitioned into a plurality of segments in the first width direction Y and the second width direction Z and penetrating in the up-down direction X. The frame portion 10a is molded integral with or separate from the housing body 10 and, similar to the housing body 10, is formed from an insulating resin material. To each of the partitioned segments of the frame portion 10a, a block (not illustrated) is detachably assembled. A terminal or the like disposed at an end of the routing member W is attached to the block, and with the block assembled to the frame portion 10a, the electronic component D is assembled from the upper side in the up-down direction X. Thus, the routing member W is electrically connected to the electronic component D via a circuit body, such as a bus bar, mounted in the block.

The top cover 20 is a lid-shaped member closing the upper opening of the housing body 10 and is also referred to as an upper cover. As illustrated in FIG. 1, the top cover 20 fits to the side wall 10Kb of the housing body 10 and is assembled via various fastening mechanisms (not illustrated). Thus, the top cover 20 assembled to the housing body 10 can block the upper opening of the housing body 10, and a space located inside the top cover 20 composes a portion of the storage space 1S.

The bottom cover 30 is a lid-shaped member closing the lower opening of the housing body 10 and is also referred to as a lower cover. As illustrated in FIG. 1, the bottom cover 30 includes a bottom wall 30Ka disposed along the first width direction Y and the second width direction Z and a side wall 30Kb extending upward from the periphery of the bottom wall 30Ka. The side wall 30Kb fits to the side wall 10Kb of the housing body 10 and is assembled via a plurality of fastening mechanisms L. Thus, the bottom cover 30 assembled to the housing body 10 can block the lower opening of the housing body 10, and a space located inside the bottom cover 30 composes a portion of the storage space 1S.

As illustrated in FIG. 1, the housing body 10 and the bottom cover 30 assembled to each other compose the routing member insertion sections 40 extending outward from side surfaces of the housing 1F (for example, the side wall 10Kb of the housing body 10).

The routing member insertion sections 40 are part of the above-described housing 1F and are sections through which the routing members W to be connected to the electronic component D are led out from the storage space 1S to an outer space. As illustrated in FIG. 1, the electrical connection box 1 of this embodiment has the routing member insertion sections 40 formed in two positions, and each of the routing member insertion sections 40 is formed on the bottom side (the bottom cover 30 side) of the housing 1F. Note that, in the following description, the two routing member insertion sections 40 may be referred to as “routing member insertion section 40A” and “routing member insertion section 40B” when distinguished from each other, and simply as “routing member insertion section 40” when no particular distinction between them is necessary. The routing member insertion section 40A is described below as a representative example of the routing member insertion sections 40.

As illustrated in FIGS. 1 and 2, the routing member insertion section 40 includes the first divided body 11 disposed on the side wall 10Kb of the housing body 10 and the second divided body 31 disposed on the bottom wall 30Ka and the side wall 30Kb of the bottom cover 30. The routing member insertion section 40 is formed by joining the first divided body 11 and the second divided body 31. Thus, the routing member insertion section 40 has a divided structure in which the first divided body 11 and the second divided body 31 are divided from each other in the up-down direction X.

As illustrated in FIGS. 2 to 8, the routing member insertion section 40 includes body portions 41A and 41B and a protruding portion 42 formed protruding from the body portion 41A along an inserting direction of the routing member W.

As illustrated in FIG. 2, the body portions 41A and 41B are portions formed to have a tubular shape when located to face each other. The body portion 41A of this embodiment is formed on the first divided body 11, and the body portion 41B is formed on the second divided body 31. The body portions 41A and 41B are each formed to have a semicircular tubular shape. Thus, the body portions 41A and 41B when joined are formed to have a circular tubular shape with both ends open, and a space located inside the body portions 41A and 41B composes a routing member storage space 40S.

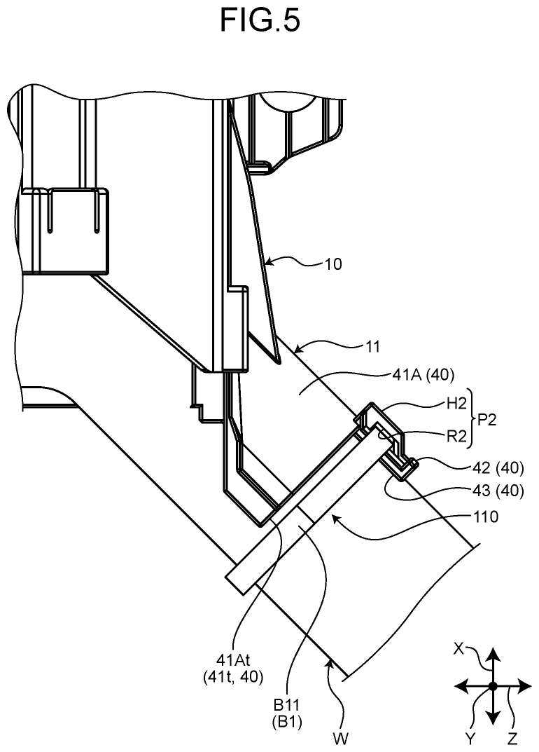

As illustrated in FIG. 3, the protruding portion 42 is a protruding piece disposed at an outlet (opening 41t) of the routing member insertion section 40 formed to have a circular shape by an opening 41At of the body portion 41A and an opening 41Bt of the body portion 41B located facing each other. The protruding portion 42 of this embodiment is disposed on the first divided body 11 on which the body portion 41A is formed. As illustrated in FIG. 3 and the like, the openings 41At and 41Bt of this embodiment are each formed to have a semicircular shape. Thus, the protruding portion 42 is formed to have a circular sector shape (for example, a quadrant shape) when viewed along an opening direction of the openings 41At and 41Bt. As illustrated in FIGS. 3 and 5, in the body portion 41A, the protruding portion 42 is disposed at part of the opening 41At, so that the remainder of the opening 41At and an edge of the protruding portion 42 form a cut-away portion 43. Thus, the cut-away portion 43 of this embodiment is formed at the first divided body 11 and is disposed in a position adjacent to the protruding portion 42.

### Routing Member Fixing Structure

As illustrated in FIGS. 1 and 2, the routing member fixing structure 100 includes the first divided body 11 and the second divided body 31 composing the routing member insertion section 40 as described above, and the first tying member B1 and the second tying member B2 wound around the respective parts of the routing member insertion section 40. The routing member fixing structure 100 also includes the first band fixing section 110 tying and fixing members around which the first tying member B1 is wound and the second band fixing section 120 tying and fixing members around which the second tying member B2 is wound.

The first tying member B1 and the second tying member B2 are members formed from a resin material or the like and capable of tying and fixing members together. The first tying member B1 includes a band portion B11 formed to have a band shape and a lock portion B12 formed at an end of the band portion B11. Similar to the first tying member B1, the second tying member B2 includes a band portion B21 formed to have a band shape and a lock portion B22 formed at an end of the band portion B21.

As illustrated in FIG. 2 and the like, the first band fixing section 110 is disposed on the protruding portion 42 of the routing member insertion section 40. Thus, the band portion B11 of the first tying member B1 is locked at the lock portion B12 while being wound around the first divided body 11 composing the protruding portion 42 and the routing member W located on the inner surface side of the first divided body 11, thereby being adjusted to have a desired length. Hence, the first band fixing section 110 can fix the position of the routing member W relative to the first divided body 11.

As illustrated in FIG. 2 and the like, the second band fixing section 120 is disposed over the body portions 41A and 41B of the routing member insertion section 40. Thus, the band portion B21 of the second tying member B2 is locked at the lock portion B22 while being wound around the first divided body 11 composing the body portion 41A and the second divided body 31 composing the body portion 41B, thereby being adjusted to have a desired length. Hence, the second band fixing section 120 ties and fixes the first divided body 11 and the second divided body 31 together with the routing member W inserted into the routing member storage space 40S of the routing member insertion section 40 and can thus fix the position of the second divided body 31 relative to the first divided body 11.

As illustrated in FIGS. 3 to 5, the first band fixing section 110 of this embodiment further includes two positioning portions P1 and P2 disposed at the protruding portion 42 of the routing member insertion section 40.

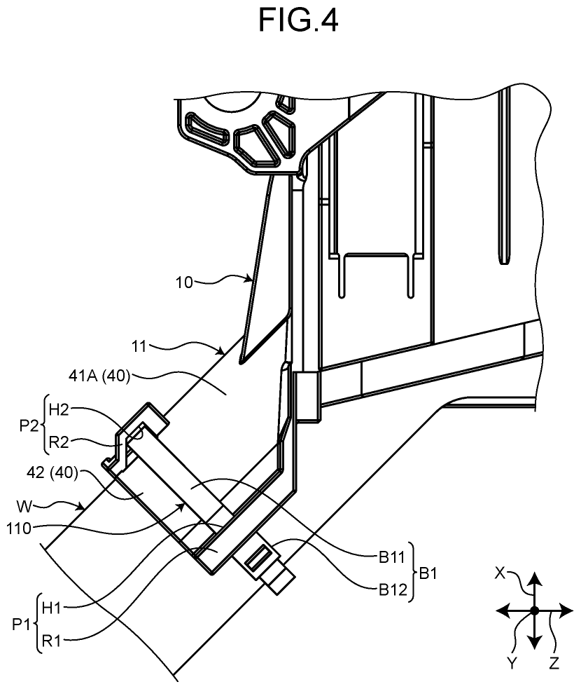

The positioning portions P1 and P2 are passage holes disposed in an outer surface 11mb of the first divided body 11 composing the protruding portion 42 and allow the first tying member B1 to be supported on the outer surface 11mb side of the first divided body 11 by inserting the first tying member B1 into the passage holes. As illustrated in FIG. 3, the positioning portions P1 and P2 of this embodiment are composed of ribs R1 and R2 formed on the first divided body 11 along the inserting direction of the routing member W and through holes H1 and H2 disposed in the respective ribs R1 and R2. Note that, herein, the rib R1 is a plate-shaped protruding piece disposed from the body portion 41A to the protruding portion 42 as illustrated in FIGS. 3 and 4, and the rib R2 is a plate-shaped protruding piece disposed only on the protruding portion 42 as illustrated in FIGS. 3 to 5. The ribs R1 and R2 of this embodiment are arranged at a predetermined interval therebetween along a peripheral direction of the protruding portion 42 (see FIG. 3). Thus, the first band fixing section 110 ties and fixes the first divided body 11 and the routing member W together with the band portion B11 of the first tying member B1 inserted into the through holes H1 and H2 and can thus prevent the band portion B11 of the first tying member B1 from being out of position. Moreover, as illustrated in FIGS. 3 and 4, the through holes H1 and H2 are formed to have such a size that only the band portion B11 of the first tying member B1 can be inserted. Thus, in the first band fixing section 110, when the band portion B11 of the first tying member B1 is inserted from the through hole H1 of the rib R1 toward the through hole H2 of the rib R2, winding can be performed with the lock portion B12 caught on the rib R1. Hence, the first band fixing section 110 can simplify operation of tying the first tying member B1 by using the positioning portions P1 and P2, which can improve workability.

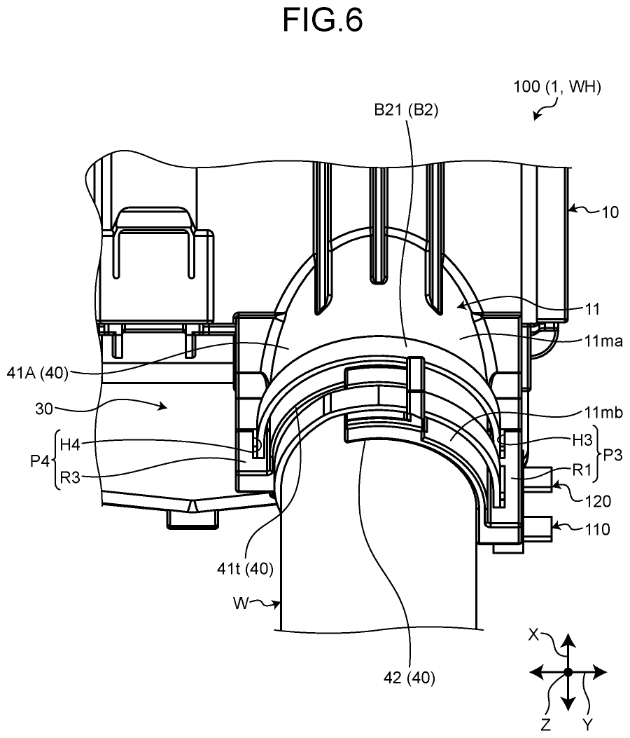

As illustrated in FIGS. 6 to 8, the second band fixing section 120 of this embodiment includes three positioning portions P3, P4, and P5 disposed at the body portions 41A and 41B of the routing member insertion section 40.

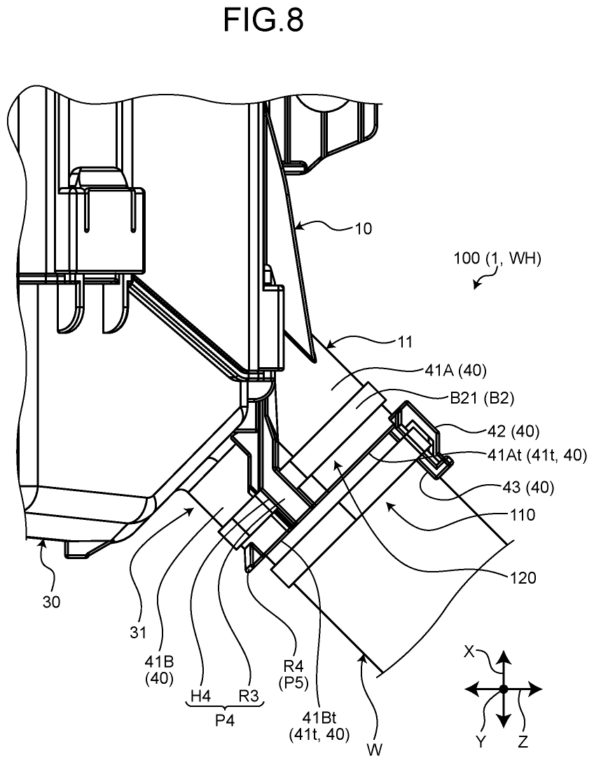

The positioning portions P3 and P4 are passage holes disposed in an outer surface 11ma of the first divided body 11 composing the body portion 41A and allow the second tying member B2 to be supported on the outer surface 11ma side of the first divided body 11 by inserting the second tying member B2 into the passage holes. As illustrated in FIG. 6, the positioning portions P3 and P4 of this embodiment are composed of the rib R1 and a rib R3 formed along the inserting direction of the routing member W and through holes H3 and H4 disposed in the respective ribs R1 and R3. Note that, herein, as illustrated in FIGS. 6 and 8, the rib R3 is a plate-shaped protruding piece disposed only on the body portion 41A. The ribs R1 and R3 of this embodiment are arranged at a predetermined interval therebetween along a peripheral direction of the body portion 41A (see FIG. 6). Thus, the second band fixing section 120 ties and fixes the first divided body 11 and the second divided body 31 together with the band portion B21 of the second tying member B2 inserted into the through holes H3 and H4 and can thus prevent the band portion B21 of the second tying member B2 from being out of position on the first divided body 11. Moreover, as illustrated in FIGS. 6 and 8, the through holes H3 and H4 are formed to have such a size that only the band portion B21 of the second tying member B2 can be inserted. Thus, in the second band fixing section 120, when the band portion B21 of the second tying member B2 is inserted from the through hole H3 of the rib R1 toward the through hole H4 of the rib R3, winding can be performed with the lock portion B22 caught on the rib R1. Hence, the second band fixing section 120 can simplify operation of tying the second tying member B2 by using the positioning portions P3 and P4, which can improve workability.

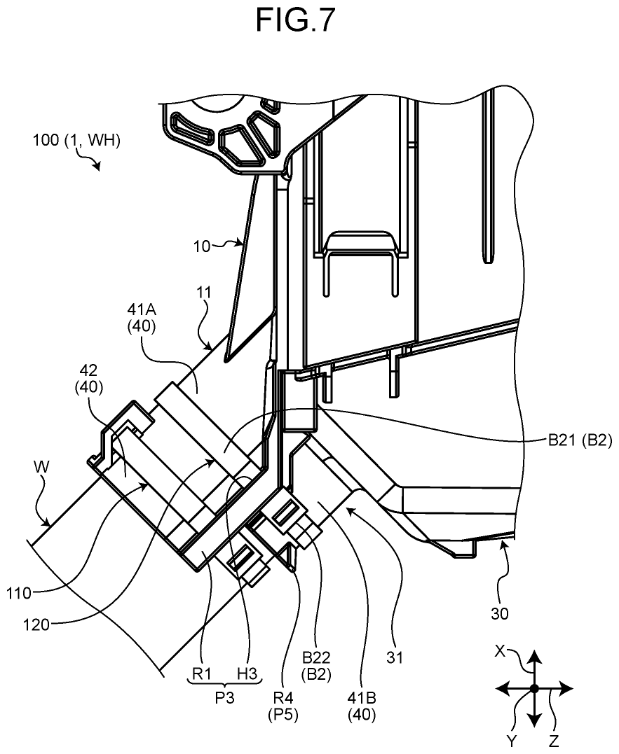

The positioning portion P5 is a protrusion disposed on an outer surface 31ma of the second divided body 31 composing the body portion 41B and allows the second tying member B2 to also be supported on the outer surface 31ma side of the second divided body 31 by winding the band portion B21 of the second tying member B2 with the protrusion using as a guide portion. As illustrated in FIGS. 7 and 8, the positioning portion P5 of this embodiment is composed of a rib R4 formed along an extending direction of the second tying member B2. The rib R4 of this embodiment has a triangular cross section and is disposed on the bottom of the second divided body 31 formed to have a semicircular tubular shape. Thus, the second band fixing section 120 ties and fixes the first divided body 11 and the second divided body 31 together with the band portion B21 of the second tying member B2 placed along the rib R4 and can thus correct the position of the band portion B21. Hence, the second band fixing section 120 can prevent the band portion B21 of the second tying member B2 from being out of position on the second divided body 31.

The routing member fixing structures 100, the electrical connection box 1, and the wire harness WH described above include the first divided bodies 11 and the second divided bodies 31 joined to each other to compose the routing member insertion sections 40 into which the routing members W are inserted, the first tying members B1 and the second tying members B2 each formed to have a band shape, the first band fixing sections 110 tying and fixing the first divided bodies 11 and the routing members W together by winding the first tying members B1 around the first divided bodies 11 and the routing members W, and the second band fixing sections 120 tying and fixing the first divided bodies 11 and the second divided bodies 31 together by winding the second tying members B2 around the first divided bodies 11 and the second divided bodies 31.

With this configuration, the first band fixing sections 110 can define insertion paths for the routing members W relative to the routing member insertion sections 40 by tying and fixing the routing members W to the first divided bodies 11. Thus, when the first divided bodies 11 and the second divided bodies 31 are joined, the first band fixing sections 110 can prevent the routing members W from getting caught between the first divided bodies 11 and the second divided bodies 31. Furthermore, the first band fixing sections 110 fix the routing members W on the first divided body 11 sides and thus allow the first divided bodies 11 and the second divided bodies 31 to be joined without pushing the routing members W against the first divided body 11 sides by the second divided bodies 31. Thus, the first band fixing sections 110 can simplify work operation in assembly, which can improve workability. Furthermore, the second band fixing sections 120 tie and fix the second divided bodies 31 to the first divided bodies 11 to which the routing members W are fixed, and thus allow the second divided bodies 31 to be assembled to the first divided bodies 11 in proper positions and the routing members W to be routed inside the first divided bodies 11 and the second divided bodies 31. Furthermore, even if occurrence of vibration or the like applies external force to the first divided bodies 11 and the second divided bodies 31, the second band fixing sections 120 can prevent joined surfaces of the first divided bodies 11 and the second divided bodies 31 from being shifted and gaps from being generated between the first divided bodies 11 and the second divided bodies 31. Thus, the second band fixing sections 120 can prevent the routing members W from getting caught between the first divided bodies 11 and the second divided bodies 31. Hence, the routing member fixing structures 100 can properly prevent the routing members W from getting caught by using the first band fixing sections 110 and the second band fixing sections 120 in combination. The electrical connection box 1 and the wire harness WH to which the routing member fixing structures 100 are applied can properly prevent the routing members W from getting caught at the routing member insertion sections 40 formed by joining the two members.

Furthermore, the first divided bodies 11 and the second divided bodies 31 described above include the body portions 41A and 41B facing each other to form the routing member insertion sections 40, the first divided bodies 11 further include the protruding portions 42 protruding from the body portions 41A of the first divided bodies 11 along the inserting directions of the routing members W, the first band fixing sections 110 are disposed on the protruding portions 42, and the second band fixing sections 120 are disposed on the body portions 41A of the first divided bodies 11 and the body portions 41B of the second divided bodies 31. With this configuration, in the routing member fixing structures 100, the second band fixing sections 120 are disposed in front of the first band fixing sections 110, so that the areas, defined by the first band fixing sections 110, of the routing positions of the routing members W can be wider than the areas where the routing member storage spaces 40S are defined by joining the first divided bodies 11 and the second divided bodies 31. Thus, the routing member fixing structures 100 can prevent play of the routing members W (instability due to undetermined positions of the routing members W) on the opening 41t sides composing the outlets of the routing member insertion sections 40 and can prevent the routing members W from getting caught between the first divided bodies 11 and the second divided bodies 31. Furthermore, in the routing member fixing structures 100, the first band fixing sections 110 are disposed on the protruding portions 42, so that the adjusting ranges of the sizes of circles formed in tying by the first band fixing sections 110 can be expanded, which enables even thin routing members W to be properly tied and fixed to the first divided bodies 11. Thus, the routing member fixing structures 100 can properly tie and fix routing members W having different specifications and diameters to the first divided bodies 11 and can properly prevent the routing members W from getting caught.

Note that the routing member fixing structures 100, the electrical connection box 1, and the wire harness WH according to the above-described embodiment of the present invention are not limited to the above-described embodiment, and various modifications can be made within the scope of the claims.

For example, the shapes of the first divided bodies 11 and the second divided bodies 31 are not particularly limited.

The positions of the first band fixing sections 110 and the second band fixing sections 120 are not particularly limited.

The number of the routing members W tied and fixed to the first divided bodies 11 via the first band fixing sections 110 is not particularly limited.

The routing member fixing structures, the electrical connection box, and the wire harness according to this embodiment may be configured by combining constituents of the above-described embodiment and modifications as appropriate.

The routing member fixing structures, the electrical connection box, and the wire harness according to the present embodiment achieve effect of properly preventing the routing members from getting caught.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing member fixing structure comprising:
a first divided body and a second divided body configured to be joined to each other to compose a routing member insertion section into which a routing member is inserted;
a first tying member and a second tying member each formed to have a band shape;
a first band fixing section configured to tie and fix the first divided body and the routing member together by winding the first tying member around the first divided body and the routing member; and
a second band fixing section configured to tie and fix the first divided body and the second divided body together by winding the second tying member around the first divided body and the second divided body.

2. The routing member fixing structure according to claim 1, wherein
the first divided body and the second divided body include body portions facing each other to form the routing member insertion section,
the first divided body further includes a protruding portion protruding from the body portion of the first divided body along an inserting direction of the routing member,
the first band fixing section is disposed on the protruding portion, and
the second band fixing section is disposed on the body portion of the first divided body and the body portion of the second divided body.

3. An electrical connection box comprising:
a housing configured to accommodate an electronic component; and
a routing member fixing structure disposed at the housing and configured to fix a routing member,
the routing member fixing structure including:
a first divided body and a second divided body composing part of the housing and configured to be joined to each other to compose a routing member insertion section into which the routing member is inserted;
a first tying member and a second tying member each formed to have a band shape;
a first band fixing section configured to tie and fix the first divided body and the routing member together by winding the first tying member around the first divided body and the routing member; and
a second band fixing section configured to tie and fix the first divided body and the second divided body together by winding the second tying member around the first divided body and the second divided body.

4. A wire harness comprising:
a routing member having conductivity; and
an electrical connection box configured to be connected to the routing member,
the electrical connection box including:
a housing configured to accommodate an electronic component; and
a routing member fixing structure disposed at the housing and configured to fix the routing member, and
the routing member fixing structure including:
a first divided body and a second divided body composing part of the housing and configured to be joined to each other to compose a routing member insertion section into which the routing member is inserted;
a first tying member and a second tying member each formed to have a band shape;
a first band fixing section configured to tie and fix the first divided body and the routing member together by winding the first tying member around the first divided body and the routing member; and
a second band fixing section configured to tie and fix the first divided body and the second divided body together by winding the second tying member around the first divided body and the second divided body.
